(19) United States
(12) Patent Application Publication
(10) Pub. No.: US 2018/0365923 A1
(43) Pub. Date: Dec. 20, 2018

(54) Fuel Dispenser Controller Wireless System

(71) Applicant: Miguel S. Giacaman, Henderson, NV (US)

(72) Inventor: Miguel S. Giacaman, Henderson, NV (US)

(21) Appl. No.: 16/108,087

(22) Filed: Aug. 21, 2018

Related U.S. Application Data
(63) Continuation-in-part of application No. 10/491,325, filed on Jul. 27, 2004, now Pat. No. 10,077,769.
Application No. 10/491,325 is a continuation-in-part of application No. 10/515,776, filed on Nov. 24, 2004.
Application No. 10/515,776 is a continuation-in-part of application No. 16/039,318, filed on Jul. 18, 2018.
(60) Provisional application No. 62/548,346, filed on Aug. 21, 2017.

(51) Int. Cl. G07F 13/06; G06Q 20/20; G06Q 50/06

(52) U.S. Cl. CPC G07F 13/06; G06Q 50/06; G06Q 20/20

(57) ABSTRACT

A method and system for fuel dispenser wireless communication having a Main Control Unit communicate wirelessly with a fuel dispenser's Dedicated Control Device. The Dedicated Control Device locates inside or nearby location at a minimal distance of the fuel dispenser. The system further includes Dedicated Control Units having electrical interface, and software or firmware for issuing control commands in accordance with a proprietary messaging protocol specified by the manufacturer of the fuel dispensers. The Main Control Unit communicates to the Dedicated Control Units by means of a messaging protocol compatible with wireless communications.

### CROSS-REFERENCE TO RELATED APPLICATION

The present application claim priority of U.S. Provisional Application No. 62/548,346 filed on Aug. 21, 2017, and is a Continuation In-Part application of the U.S. Nonprovisional application Ser. No. 10/491,325 filed on Jul. 27, 2004, Ser. No. 16/039,318 filed on Jul. 18, 2018, and Ser. No. 10/515,776 filed on Nov. 24, 2004 each in their entirety incorporated herein by reference.

### BACKGROUND

### 1. Field of the Invention

The present invention relates to a fuel dispenser control system and method for remotely and wirelessly controlling Dedicated Control Devices installed inside or proximately close to a fuel dispenser by a Main Control Unit via a wireless communication channel and a wireless compatible messaging protocol.

### 2. Background of the Invention

A fuel dispenser controller is an electronic interface that connects a fuel management system or POS with one or more fuel dispensers. A conventional fuel dispenser controller communicates the fuel dispensers via wired links and messaging according to the protocol specification of the manufacturers of the fuel dispensers.

Presently, the connection between the fuel dispenser controller and the POS is done with a short cable and at a short distance within the offices in the same building. Sometimes, POS and fuel dispenser controller can be integrated as one equipment. But, the connection between the fuel dispenser controller and the fuel dispensers is at a longer distance via wiring through under the pavement tubing. This connection has many problems arising from electrical interference to water inundation of under pavement (or underground) tubes. In addition, lightning strikes target that wiring damaging the dispenser controller and the fuel dispenser's electronics.

A prior art discloses a wireless communication link that has been developed to resolve the problems of connecting the dispenser controller with the fuel dispensers merely “to allow replacement of conventional wired connections with wireless RF modules without having to modify the existing protocol, meaning to use the dispenser's proprietary messaging protocol (Blanchard) unchanged or packetized to allow wireless communication.

Several attempts have been done to implement such a wireless communication but all have failed due to the nature of the proprietary messaging protocols that are in use with most of the dispensers that are not tolerant to timing fluctuations characteristics of a wireless link. For example, it takes several command interchanges to setup the fuel dispenser for an authorization to dispense a maximum volume a driver of a vehicle may request. In some dispenser's messaging protocols, the dispenser controller sends a first command to preset a maximum volume to dispense and a second command to authorize the fuel dispenser to dispense the fuel. In case there is any delay beyond a specific time limit after sending the volume preset, the fuel dispenser times out and cancels the volume preset. However, because the dispenser controller does not receive a time out signal for the cancelation of the volume preset, it continues sending the authorization to dispense the fuel. As the result, the fuel dispenser keeps dispensing the fuel beyond the failed preset volume, resulting on a delivery of a volume of fuel higher than requested by the driver of the vehicle.

Another prior art, connects via wirelessly a POS with a plurality of complete dispenser controllers inside each fuel dispenser. This possess several drawbacks, since the fuel dispenser controller is the equipment that connects all the fuel dispensers in the station and to at least one POS, then POS are designed to connect either via serial port or Ethernet protocol to just one fuel dispenser controller and not to a plurality of controllers, some stations have 12 and even 18 fuel dispensers, then it would be up to 18 complete dispenser controller to communicate with. Neither a fuel management system nor a point of sales (POS) are a real time control equipment and they can't handle the communications with a plurality of controllers, including incomplete data string, retries of commands, interference with the wireless channel, re-routing the data through wireless repeaters or coordinating a MESH wireless network topology. Additionally, a complete fuel dispenser controller per fuel dispenser is not cost effective and may impose physical installation limitations.

There is a need for a control and communication system and method for a fuel dispenser controller to communicate information data relating to fueling transactions and control fuel dispensers effectively and reliably via a wireless channel.

### SUMMARY OF THE INVENTION

### Definitions

The term “dispenser” means a dispensing equipment used to deliver fuel to vehicles at fuel service stations, also known as fuel pump. A fuel dispenser is divided into two main parts; a lower part, containing the electromechanical elements including the meters, pulsars and valves to control the fuel flow; and an upper part containing a pump computer and associated electrical components to compute the signals from the fuel meter, drive the primary displays, communicate to an indoor sales system and controls the electromechanical elements on the lower part. Both parts are separated by a safety divider called “vapors barrier.”

The term “pump computer” means the electronic computer system inside a fuel dispenser. It locates on the upper part of a dispenser inside an enclosure separated from the lower part of the dispenser by a safety barrier called “vapors barrier” that prevents fuel vapors to enter the electric space on top. The pump computer computes the signals provided by the electromechanical fuel metering system, calculates at least the amount and volume dispensed and shows these values along with PPU and product selected on the primary display. Additionally, the pump computer control most aspect of the operation of the dispenser, including but not limited to the fuel valves and sensing the nozzle activation. One important feature of the pump computer is to provide with a data communications line to send information in and out of the dispenser. This data communications line can connect with internal or external fuel dispenser control equipment or system.

The term “Dispenser Control System” means an electronic equipment capable of sending and receiving controlling messages to one or more fuel dispensers using protocol specified by the manufacturer of the fuel dispenser and communicating all pertinent data to a POS or fuel management system and receiving action commands to be executed by the fuel dispenser.

The term “Local and Remote” means the purpose of this patent, Local is when the device or equipment is located in the office and remote when it is located in one of the gas station islands. For the purpose of this patent, a fuel service station is divided into two locations, the office and the site. The office is usually a building structure for the administration of the station and can optionally be a convenience store or any associated business. Any structure were the electric panels, control equipment, power generators and a plurality of support equipment for the operation of the station is located are considered part of the office. The site is where the fueling operations are conducted; it includes the island and the pavement for the vehicles. The islands are where the fuel dispensers are located and also support the roof. The fuel dispensers electric and data wiring reach the island via underground conduits connecting the office with the island, hence, a Remote device or equipment would be connected to the wiring emerging from the island end of said underground conduits and a Local device or equipment would be connected to the wiring emerging from the office end of said underground conduits.

The term “Dedicated Control Device” means a dispenser controlling device installed on at least one fuel dispenser, proximate and in connection with each pump computer inside each fuel dispenser. The device is capable of functioning as a dispenser controller at a remote positioned, meaning, inside or proximate to a fuel dispenser. This dedicated dispenser controller contains a microcomputer with a dispenser brand-specific communication interface like a current loop, RS232 or RS485 serial interfaces. By means of a RF transceiver establishes a wireless communication channel to connect with a Main Control Unit, which is non-dedicated and has control over one or more dedicated dispenser controllers at the gas station. A Dedicated Control Device may function as a slave of the Main Control Unit and, in case of a failure of the communication with the Main Control Unit it may change into master mode functioning autonomously to control the fuel dispenser on its own. For the purpose of this patent, the term “dedicated” doesn't mean for just one dispenser, but rather means proximate or inside one or more dispensers in one area of the station considered to be on a remote position as defined here.

The term “Wireless Communication Channel” means a radio frequency communication link between a Dedicated Control Devices and a Main Control Unit via a RF Transceiver. This allows the Main Control Unit to send and receive controlling messages and data strings to and from one or more Dedicated Control Units by means of an Internal Communication Protocol (ICP).

The term “Main Control Unit” means a unit that connects wirelessly to at least one of a plurality of dedicated control devices on a remote position and also connects with a Fuel Management System, which may include a POS or any other type of electronic fuel management equipment.

The term “Internal Communication Protocol (ICP)” means any protocol used to communicate the Main Control Unit with the plurality of Dedicated Control Devices. The condition for this protocol to become an ICP is to be compatible with a wireless communication channel.

The term “POS” refers to a point of sale or any other type of electronic fuel management system. And the term “fuel management system” refers to any computerized system to administrate the operation, management and financials aspects of a fuel service station, including processing of payment from clients. The terms “POS” and “fuel management system” are used indistinctively in this patent.

### SUMMARY

The present invention provides a fuel dispenser control system and method for remotely controlling the operations of the fuel dispensers via wireless communication link and wireless compatible messaging protocol. The fuel control system is divided into two types of components (1) the Main Control Unit that maintain a connection to the POS and (2) the Dedicated Control Devices that maintain a connection to a fuel dispenser via a wire connection while using their native communication protocol. The Main Control Unit communicates with the Dedicated Control Devices via a wireless channel.

Each Dedicated Control Device is installed inside or near each fuel dispenser and connected via a short (or local) wire to send and receive commands and data to and from the fuel dispensers it is connected to. These Dedicated Control Devices communicate with the Main Control Unit using at least one wireless channel and an Internal Communication Protocol (ICP) that is designed for a wireless link and its procedures, capacities and limitations.

The fuel dispenser control system controls the fuel dispensers via its Dedicated Control Devices using a conventional wired connection.

Each Dedicated Control Device have a program code to be executable by its computer or microcomputer for processing time sensitive sequences of controlling commands independently of the Main Control Unit.

The term “Time Sensitive Sequences of Controlling Commands” means a sequence of messages or controlling commands that needs to be sent and receive within a time frame specified by the manufacturer of the fuel dispenser. One of these sequences is for example, that in some dispenser's messaging protocols, the dispenser controller needs to send a first command to preset a maximum volume to dispense, receive a signal from the dispenser to proceed with the next command or data and then send a second command to authorize the fuel dispenser to dispense the fuel. In case there is any delay beyond a specific time limit after sending the volume preset, the fuel dispenser times out and cancels the volume preset. However, because there is not a time out signal back from the dispenser to the controller to indicate that the preset and authorization procedure should be canceled, the controller continues with sending the authorization to dispense the fuel. As the result, the fuel dispenser keeps dispensing the fuel beyond the failed preset volume, resulting on a delivery of a volume of fuel higher than requested by the driver of the vehicle.

The present invention is compatible with conventional fuel dispenser connectivity and with conventional POS or fuel management systems.

In another preferred embodiment of the present invention, the Main Control Unit authorizes the fuel dispenser to dispense fuel via the Dedicated Control and collects information from the fuel dispenser via the wireless network communication messaging protocol referred as Internal Communication Protocol (ICP). Additionally, once authorized by the POS, the Main Control Unit transmits wirelessly a signal to the Dedicated Control Device installed near or inside the designated fuel dispenser. This signal authorizes the Dedicated Control Device on the fuel dispenser to authorize the fuel dispenser to dispense the selected product in the preset amount or volume indicated by the POS.

In another preferred embodiment of the present invention, a wireless transceiver located on or near the fuel dispensers re-transmits a signal to a transceiver located in or near another fuel dispenser to find a wireless path to the wireless message destination to or from the Main Control Unit. Therefore, the permissible distance between one transceiver and another transceiver is limited only by the strength of the transmitted signals and the receiving sensitivity of the intended transceivers, as well as the line of site and obstacles that could block the wireless signal.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 depicts a prior art dispenser control system that communicates via wired data ports where the central dispenser controller is located close to the POS and communication to the fuel dispenser is hard wired.

FIG. 2 depicts another prior art of dispenser control system that communicates with fuel dispensers via the dispenser proprietary protocol on a wireless channel.

FIG. 3 depicts another prior art of fuel management system that communicates via a wireless channel with a complete pump control system installed inside each fuel dispenser, in which each pump control system communicates with the pump computer in the fuel dispenser via the dispenser proprietary protocol on a wired connection.

FIG. 4 depicts a fuel management system or POS connected to a dispenser control system comprised of a Main Control Unit that connects via a wireless channel with the Dedicated Control Devices installed inside each fuel dispenser.

### DETAILED DESCRIPTION OF THE DISCLOSURE

The embodiments set forth below represent the necessary information to enable those skilled in the art to practice the invention and illustrate the bet mode of practicing the invention. Upon reading the following description in light of the accompanying drawing figures, those skilled in the art will understand the concepts of the invention and will recognize applications of these concepts not particularly addressed herein.

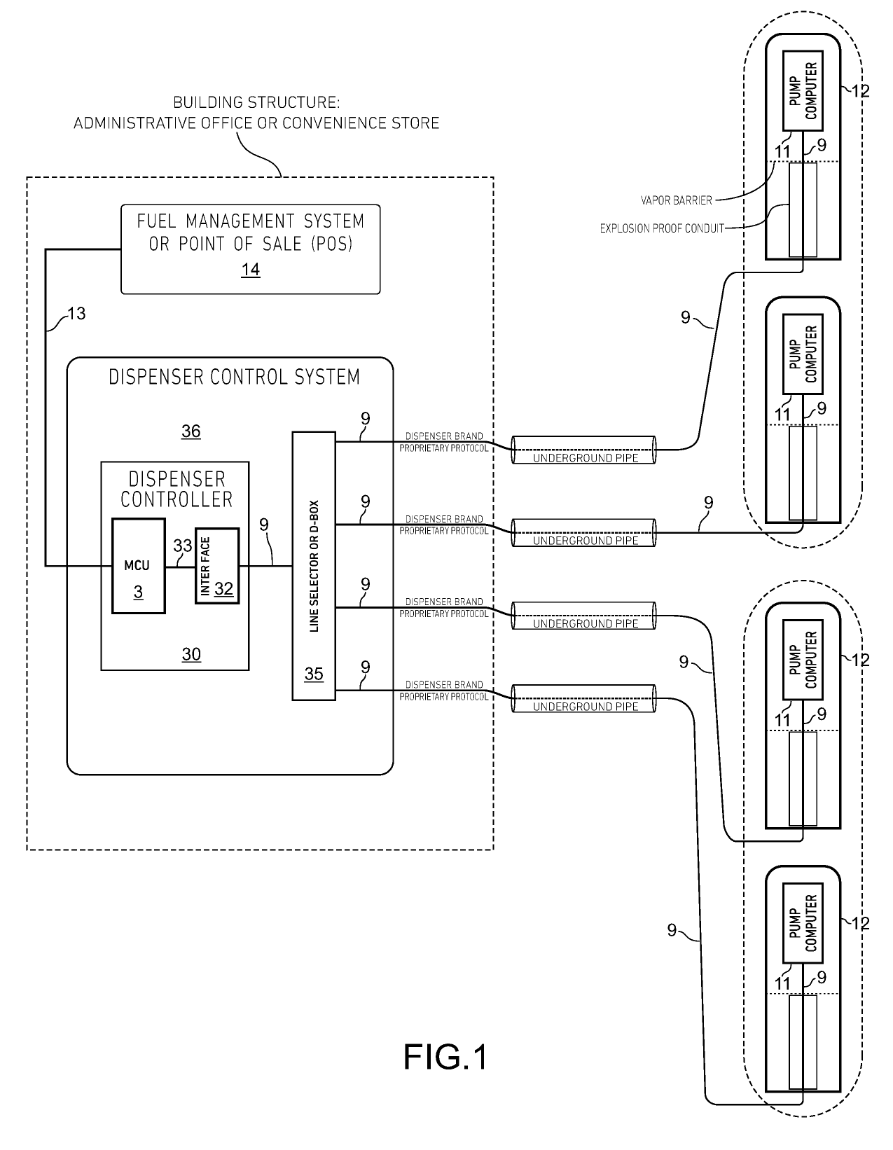

FIG. 1 is a prior art dispenser control system showing a fuel management system or POS 14 connected to a conventional dispenser control system 36 having components 30 and 35. The dispenser controller 30 includes a computer or microcontroller MCU 3, a data line 33 connected to an interface 32 that is compatible with the dispenser's specifications. The data line 9 connects to the pump computers 11 located inside the fuel dispensers 12. The D-Box 35 is an electrical connection box that just connects the digital data line 9 coming from the interface 32 to the digital data line 9 going to each fuel dispenser 12.

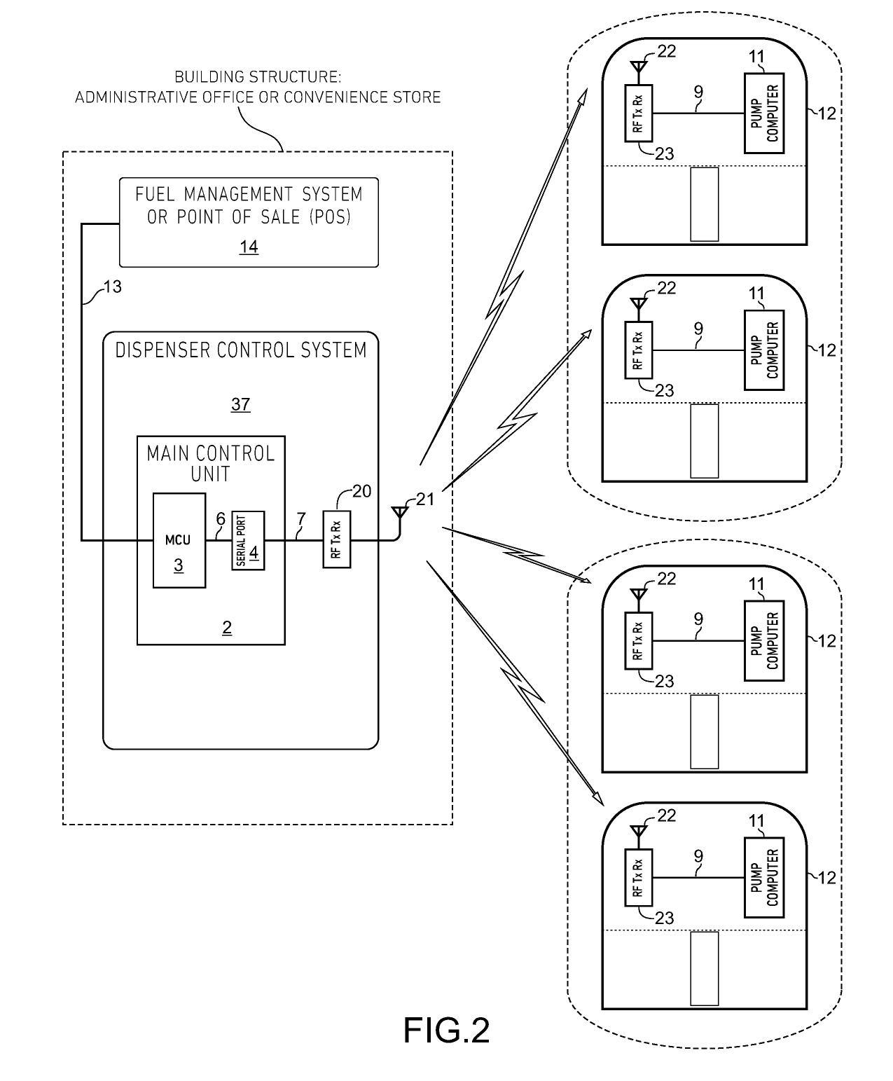

FIG. 2 depicts another prior dispenser control system showing a fuel management system or POS 14 connected to a dispenser control system comprised of components 37, 2, 7, 20, 21, 22 and 23. The Main Control Unit 2 is having a computer or a microcontroller unit (MCU) 3 connected to a serial port 4 via a data line 6. The serial port 4 connects to the radio frequency transceiver 20 via a data line 7. The radio frequency transceiver 20 connects wirelessly with the remote transceivers via antennas 21 and 22. Each remote transceiver 23 communicates the data line 9 and the dispenser proprietary protocol with the Pump Computer 11 via an appropriate interface to control its associated fuel dispenser 12.

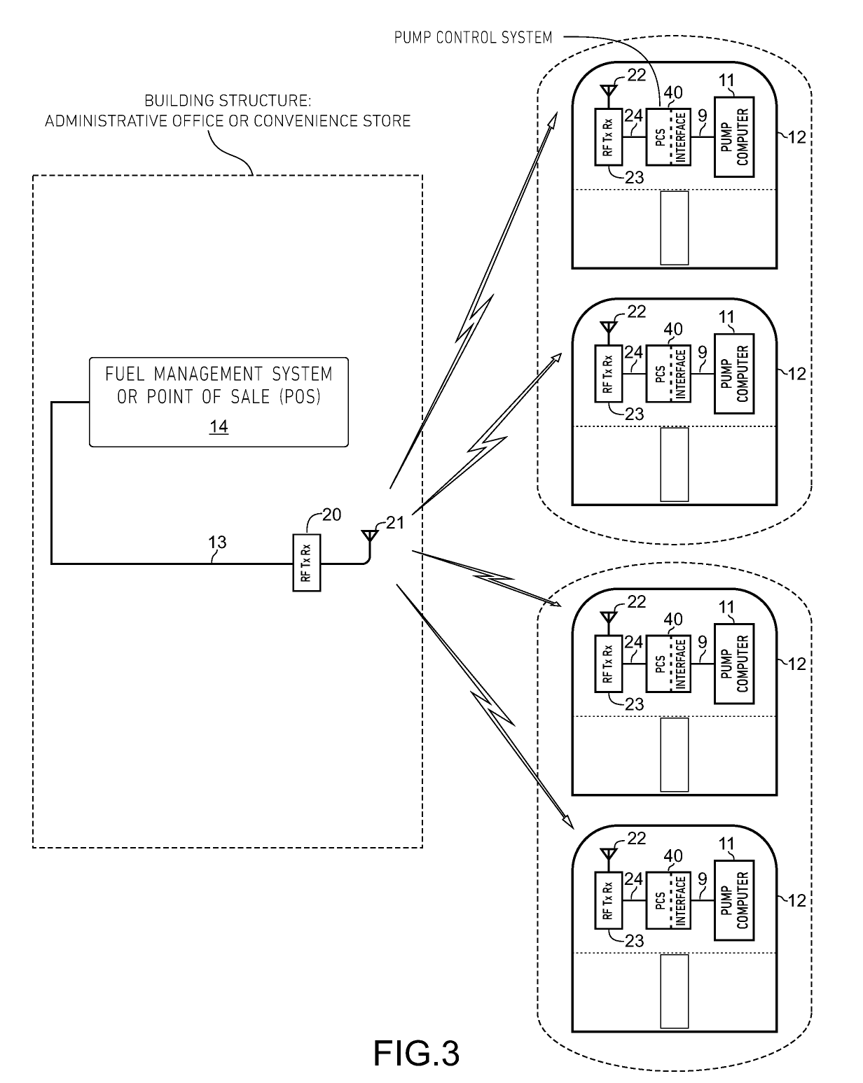

FIG. 3 depicts another prior dispenser control system showing a fuel management system or POS 14 that connects to a plurality of complete pump control systems 40 installed inside each fuel dispenser 12 via a wireless link comprised of and including data line 13, RF Transceiver 20, antennas 21 and 22, RF Transceivers 23 and data line 24. Each of the complete pump control systems 40, a data line 9, and the dispenser proprietary protocol communicates with the Pump Computer 11 to control its associated fuel dispenser 12 via an appropriate interface.

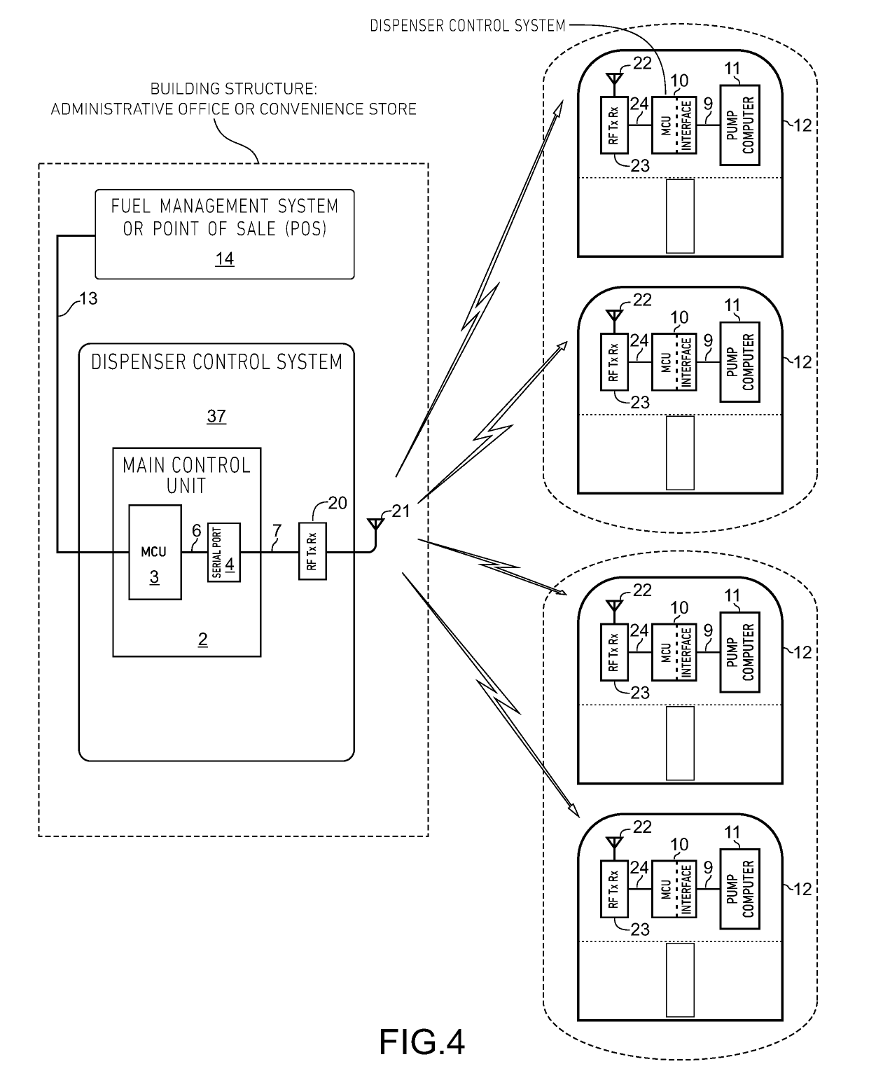

FIG. 4 is a preferred embodiment of the present invention showing a fuel management system or POS 14 connected to a dispenser control system having components 37, 21, 22, 23, 24 and 10. The Main Control Unit 2 includes a computer or a microcontroller unit (MCU) 3 connected to a serial port 4 via a data line 6. The serial port 4 connects to the radio frequency transceiver 20 via a data line 7. The radio frequency transceiver 20 connects wirelessly with the remote transceivers via antennas 21 and 22. Each remote transceiver 23 connects to a Dedicated Control Unit 10 via a wired data link 24. Each Dedicated Control Units 10 uses an Internal Communication Protocol (ICP) to communicate wirelessly with the Main Control Unit 2 by means of an appropriate interface. The data line 9 and the dispenser proprietary protocol communicates with the Pump Computer 11 to control its associated fuel dispenser 12.

As various modifications could be made to the exemplary embodiments, as described above with reference to the corresponding illustrations, without departing from the scope of the invention, it is intended that all matter contained in the foregoing description and shown in the accompanying examples shall be interpreted as illustrative rather than limiting. Thus, the breadth and scope of the present invention should not be limited by any of the above described exemplary embodiments, but should be defined only in accordance with the following claims appended hereto and their equivalents.

It should be understood that these concepts and applications fall within the scope of the disclosure and the accompanying claims.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. A fuel dispenser control system for communicating with a fuel management system and a plurality of fuel dispensers comprising:
a main control unit including at least one computerized device communicatively linked to said fuel management system;
at least one dedicated control device, wherein said at least one dedicated control device is installed inside or proximate to a single fuel dispenser, and said at least one dedicated control device is communicatively linked with said main control unit using a wireless optimized internal communication protocol; and
a wireless channel comprising:
at least one radio frequency transceiver connected with said main control unit; and
at least one radio frequency transceiver connected to at least one dedicated control device, wherein said main control unit is communicatively linked to at least one dispenser control device via said wireless channel.

2. The fuel dispenser control system of claim 1, wherein said at least one dedicated control device further comprises:
at least one processor;
data memory for storing transaction information regarding fueling operations of said fuel dispenser in said data memory;
at least one fuel dispenser communication interface directly connected to at least one pump computer for controlling said at least one fuel dispenser;
a program code to be executable by said at least one processor for processing time sensitive sequences of controlling commands independently of said main control unit; and
a program code to be executable by said at least one processor for controlling said at least one fuel dispenser independently from said main control unit.

3. The fuel dispenser control system of claim 1, wherein said main control unit locates in local position in the fuel service station, and said plurality of fuel dispenser control devices locate in remote position in the fuel service station.

4. The fuel dispenser control system of claim 1, wherein said main control unit and said plurality of fuel dispenser control devices locate in remote position in the fuel service station.

5. The fuel dispenser control system of claim 1, wherein said wireless channel transfers data from said at least one dedicated control device to said main control unit.

6. The fuel dispenser control system of claim 1, wherein said dedicated control device further comprises:
a program code to be executable by said at least one processor for controlling dispensing operations by said at least one dedicated control device independently from said main control unit wherein said wireless channel is inactive; and
a program code to be executable by said at least one processor for controlling dispensing operations by said at least one dedicated control device dependently from said main control unit wherein said wireless channel is active.
